(19) United States
(12) Patent Application Publication
(10) Pub. No.: US 2015/0100955 A1
(43) Pub. Date: Apr. 9, 2015

(54) Method and System for Updating Software

(71) Applicant: Tencent Technology (Shenzhen) Company Limited, Shenzhen City (CN)

(72) Inventors: Qiru Chen, Shenzhen City (CN); Kefeng Nie, Shenzhen City (CN); Yang Liu, Shenzhen City (CN); Qi Xiong, Shenzhen City (CN)

(73) Assignee: TENCENT TECHNOLOGY (SHENZHEN) COMPANY LIMITED, Shenzhen City (CN)

(21) Appl. No.: 14/568,154

(22) Filed: Dec. 12, 2014

Related U.S. Application Data
(63) Continuation of application No. PCT/CN2013/076963, filed on Jun. 7, 2013.

(30) Foreign Application Priority Data
Jun. 13, 2012 (CN) 201210195031.8

(51) Int. Cl. G06F 9/44; H04L 29/08; G06F 9/445

(52) U.S. Cl. CPC G06F 8/68; G06F 8/65; H04L 67/34
USPC 717/170

(57) ABSTRACT

A method, system and computer readable storage medium for updating software are disclosed. The method includes the following steps: sending upgrade query information to a server by a client, the upgrade query information including client version information; receiving update information from the server by the client when the server determines an upgrade is needed according to the client version information and server upgrade target version information, the update information including incremental update package information; sending download request information to the server by the client, the download request information including the incremental update package information; receiving, by the client, an incremental update package sent by the server, the package matching with the incremental update package information, and updating according to the incremental update package. By the above method, it reduces downloaded data volume when upgrading, therefore occupying less bandwidth when downloading, and increasing the download success rate.

### CROSS REFERENCE TO RELATED APPLICATIONS

This application is a continuation application of International Application No. PCT/CN2013/076963, filed Jun. 7, 2013, which claims priority to Chinese Patent Application No. CN201210195031.8, filed Jun. 13, 2012, the contents of which are incorporated herein by reference in their entirety.

### TECHNICAL FIELD

The present disclosure relates generally to the field of Internet technology, and more particularly to a method, system, and non-transitory computer-readable storage medium for updating software.

### BACKGROUND

Usually, existing software may require upgrade in case of patch repair, function expansion, etc. during its use. The software upgrade usually takes a form of full-volume update which refers to an update using a complete installation package containing all program files and data files. The specific update procedure by way of full-volume update includes: a client, at the start of its operation, or in a while after such start, sending upgrade query information to a server to check for updates, the upgrade query information including current client version information; the server, after receiving the upgrade query information, determining whether an upgrade is needed by comparing the version numbers of the target version (server version) and the client version, wherein an upgrade is not required if the client version number is higher than or equal to the server version number, otherwise (i.e., if the former is lower than the later) an upgrade is required; the server, when an update is required, sending back to the client the information to be updated along with update information, the update information comprising address information of upgrade files, etc; the client, when receiving the feedbacks sent by the server, and when the user confirms the update, downloading the upgrade files and performing the full-volume installation package as an overwrite installation during the upgrade. This upgrade type of full-volume update requires downloading a complete installation package containing all program files and data files. The complete installation package has a large data volume which requires relatively large amount of bandwidth resources and may have a low download success rate. It requires relatively large amount of Internet flow and long upgrade time, which affects user experience.

### SUMMARY

In view of the above, there is a need to provide a method, system and non-transitory computer-readable storage medium for updating software, which may save bandwidth, improve download success rate, reduce upgrade and update time length, therefore enhancing user experience during software upgrade and update.

According to one aspect of the disclosure, a method for updating software includes:

sending, by a client, upgrade query information to a server, the upgrade query information including client version information;

receiving, by the client, update information from the server when the server determines an upgrade is needed according to the client version information and server upgrade target version information, the update information including incremental update package information;

sending, by the client, download request information to the server, the download request information including the incremental update package information;

receiving, by the client, an incremental update package sent by the server, the package matching with the incremental update package information, and updating according to the incremental update package.

According to another aspect of the disclosure, a method for updating software includes:

receiving upgrade query information, the upgrade query information including client version information;

determining whether an upgrade is needed according to the client version information and server upgrade target version information; if so, sending update information to the client, the update information including incremental update package information;

receiving download request information sent by the client, the download request information including the aforementioned incremental update package information, and sending an incremental update package to the client for the client to update, the package matching with the incremental update package information.

According to a further aspect of the disclosure, a system for updating software implemented in a client, comprising one or more processors; and a memory having instructions stored thereon, the instructions, when executed by the one or more processors, cause the processors to perform operations comprising:

sending upgrade query information to a server, the upgrade query information comprising client version information;

receiving update information from the server when the server determines an upgrade is needed according to the client version information and server upgrade target version information, the update information comprising incremental update package information;

sending download request information to the server, the download request information comprising the incremental update package information; and

receiving an incremental update package sent by the server, the package matching with the incremental update package information, and updating according to the incremental update package.

In conclusion, when the server receives upgrade query information sent by the client, the server returns an incremental update package for the client to download when an upgrade is needed. The client downloads an incremental update package and upgrade and update the software according to the incremental update package. It is unnecessary to download a complete full-installation package from the server, which greatly reduces data volume downloaded during upgrading, therefore occupying less bandwidth during downloading and saving bandwidth, increasing the download success rate, and reducing the time consumed by upgrades and updates.

### BRIEF DESCRIPTION OF THE DRAWINGS

FIG. 1 is a schematic diagram of a method for updating software according to a first embodiment of the disclosure.

FIG. 2 is a schematic diagram of a method for updating software update method according to a second embodiment of the disclosure.

FIG. 3 is a schematic diagram of a method for updating software according to a third embodiment of the disclosure.

FIG. 4 is a schematic diagram showing a principle for generating incremental update package according to one embodiment of the disclosure.

FIG. 5 is a structural schematic diagram of a system for updating software according to one embodiment of the disclosure.

FIG. 6 is a partial structural diagram of a terminal device according to one embodiment of the disclosure.

FIG. 7 is a partial structural diagram of a server according to one embodiment of the disclosure.

### DETAILED DESCRIPTION OF THE PREFERRED EMBODIMENTS

In the following description of embodiments, reference is made to the accompanying drawings which form a part hereof, and in which it is shown by way of illustration specific embodiments of the disclosure that can be practiced.

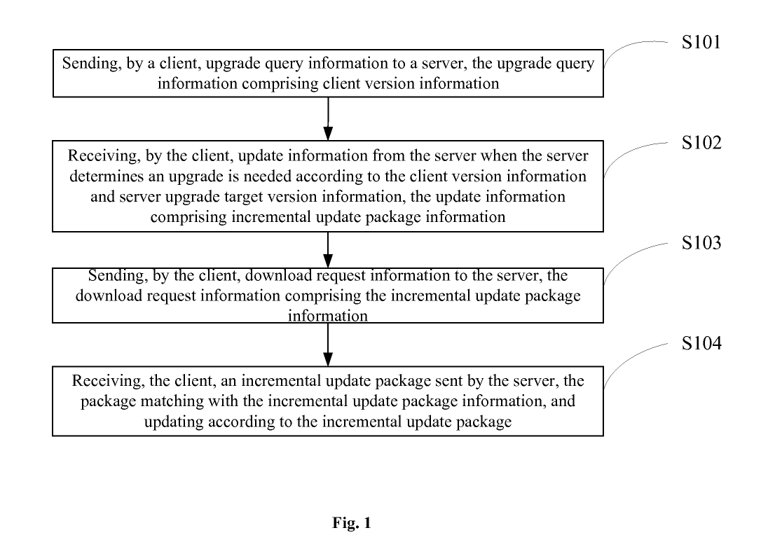

FIG. 1 is a schematic diagram of a method for updating software according to a first embodiment of the disclosure. In this embodiment, it will be illustrated, by way of example, by the processing procedure of a client.

As illustrated by FIG. 1, the processing procedure of a client may include the following steps.

Step S101: sending, by a client, upgrade query information to a server, the upgrade query information including client version information.

Step S102: receiving, by the client, update information from the server when the server determines an upgrade is needed according to the client version information and server upgrade target version information, the update information including incremental update package information.

Step S103: sending, by the client, download request information to the server, the download request information comprising the incremental update package information.

Step S104: receiving, by the client, an incremental update package sent by the server, the package matching with the incremental update package information, and updating according to the incremental update package.

With this embodiment, when a client sends upgrade query information to a server, the server returns an incremental update package for the client to download when an upgrade is needed. The client downloads an incremental update package and upgrade and update the software according to the incremental update package. It is unnecessary to download a complete full-installation package from the server, which greatly reduces downloaded data volume when upgrading, therefore occupying less bandwidth when downloading and saving bandwidth, increasing the download success rate, and reducing the time consumed by upgrades and updates.

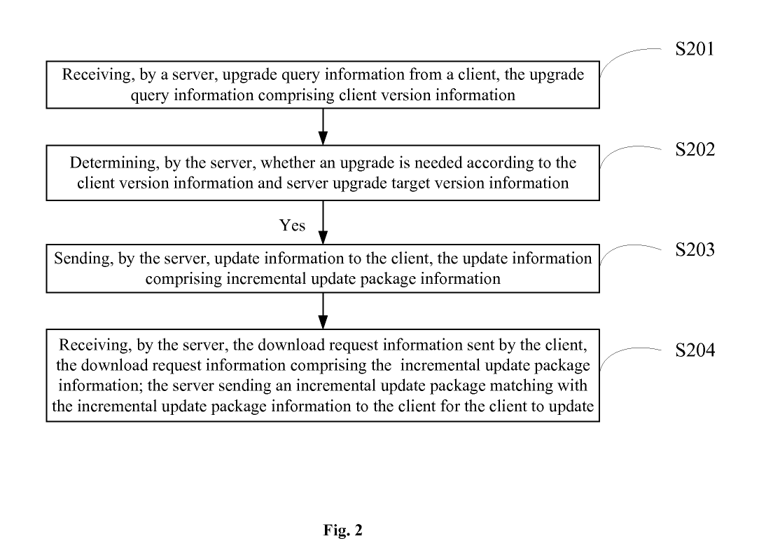

FIG. 2 is a schematic diagram of a method for updating software according to a second embodiment of the disclosure. In this embodiment, it will now be described, by way of an example of the processing procedure of a server.

As illustrated by FIG. 2, the processing procedure of a server may include the following steps.

Step S201: receiving, by a server, upgrade query information from a client, the upgrade query information including client version information.

Step S202: determining, by the server, whether an upgrade is needed according to the client version information and server upgrade target version information; if so, proceeding to Step S203.

Step S203: sending, by the server, update information to the client, the update information including incremental update package information.

Step S203: receiving, by the server, the download request information sent by the client, the download request information including the aforementioned incremental update package information; the server sending an incremental update package to the client, the package matching with the incremental update package information, for the client to update.

With this embodiment, when a server receives upgrade query information sent by a client, the server returns an incremental update package for the client to download when an upgrade is needed. The client downloads an incremental update package and upgrade and update the software according to the incremental update package. It is unnecessary to download a complete full-installation package from the server, greatly reducing downloaded data volume when upgrading, therefore occupying less bandwidth when downloading and saving bandwidth, increasing the download success rate, and reducing the time consumed by upgrades and updates.

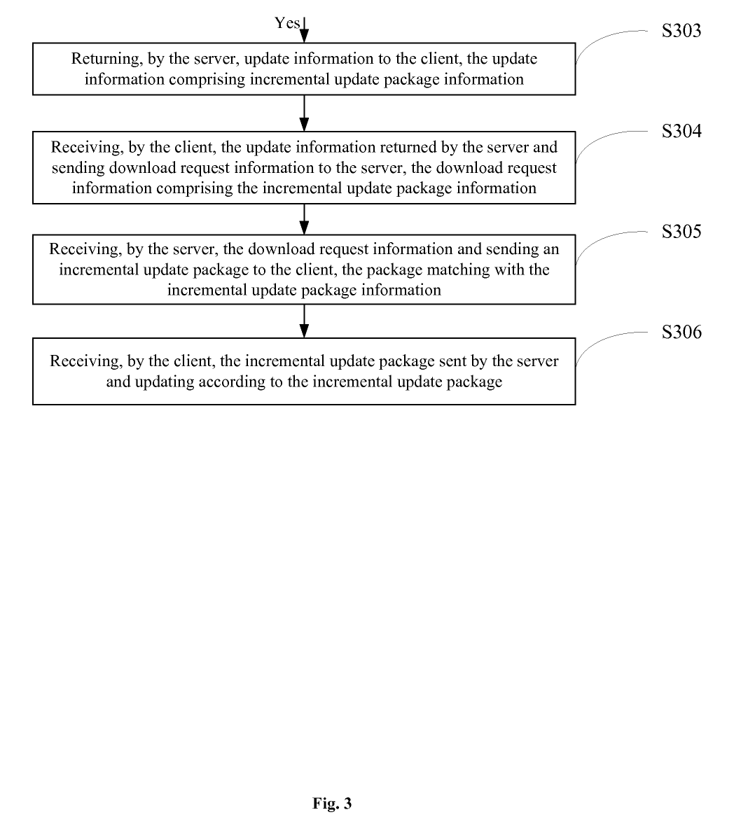

FIG. 3 is a schematic diagram of a method for updating software according to a third embodiment of the disclosure, as a combination of the technical solutions in the first and second embodiments above. This embodiment will be illustrated, by way of an example of the bidirectional interaction process between a server and a client during software update, which is not intended to limit the scope of the current disclosure in any aspect.

As illustrated by FIG. 3, the method according to the current example may include:

Step S301: sending, by a client, upgrade query information to a server, the upgrade query information comprising client version information; entering Step S302.

Step S302: receiving, the server, the upgrade query information from the client and determining whether an upgrade is needed according to the client version information and server upgrade target version information; if an upgrade is needed, entering Step S303.

Step S303: returning, by the server, update information to the client, the update information including incremental update package information, entering Step S304.

Step S304: receiving, by the client, the update information returned by the server and sending download request information to the server, the download request information including the incremental update package information, entering Step S305.

Step S305: receiving, by the server, the download request information and sending an incremental update package to the client, the package matching with the incremental update package information, entering Step S306.

Step S306: receiving, by the client, the incremental update package sent by the server and updating according to the incremental update package.

According to this embodiment, when a server receives upgrade query information sent by a client, the server returns an incremental update package for the client to download when an upgrade is needed. The client downloads an incremental update package and upgrade and update the software according to the incremental update package. It does not require downloading a complete full-installation package from the server, greatly reducing downloaded data volume when upgrading, therefore occupying less bandwidth when downloading and saving bandwidth, increasing the download success rate, and reducing the time consumed by upgrades and updates.

In one embodiment, the incremental update package includes a set of listed files of differences determined from server upgrade target version information.

The aforementioned update information may further include MD5 information (Message-Digest Algorithm 5, which calculates another value of fixed length for the data as a way to ensure the integrity and consistency of information transmission) in an incremental update package. Thus, when an incremental update package is downloaded by a client (receiving an incremental update package sent by the server), it may further verify the correctness and integrity of the incremental update package by comparing the MD5 information in the update information and the MD5 information in the downloaded incremental update package in order to determine their consistency.

In another aspect, the update information above may further include address information of an incremental update package. Thus, a client may send a download request for the incremental update package to the network address according to the aforementioned address information, the network address matching the aforementioned address information.

As described above, the embodiment implements software update and upgrade with an incremental update package. An incremental update package is generated according to server upgrade target version information, which includes all files of differences between the two versions. For example, if Version 1 contains a file set of {A1, A2, A3} and an upgraded Version 2 contains a file set of {A1, B2, B3}, then the listed files of differences between Version 1 and Version 2 comprises file B2 and B3. In other words, if Version 1 contains a file set of {A1, A2, A3} and an upgraded Version 2 contains a file set of {B1, B2, B3}, wherein A1=B1, A2≠B2, and A3≠B3, then the listed files of differences between Version 1 and Version 2 includes file B2 and B3.

As a result, incremental update packages may be generated in any way possible, according to actual requirements, so that a client may download an incremental update package and use it to upgrade and update to a target version (server upgrade target version). Details will be described below to illustrate two operational aspects of the disclosure by way of example.

According to one embodiment, an incremental update package may be generated by creating a union of the listed files of differences between the current and the last server upgrade target version information and the last incremental update package.

Details will be described below, by way of example, regarding a generating method of an incremental update package (hereinafter referred to as “KB package”), the example being generating an incremental update package by creating a union of the listed files of differences between the current and the last server upgrade target versions and the last incremental update package.

In one embodiment, the incremental update package is in fact a set of the listed files of differences between the two software versions. In practical application, an outgoing KB package may be obtained by creating an union of the listed files of differences in the last KB package and the listed files of differences between the two current the versions, wherein:

Outgoing KB package=(listed files of differences in the last KB package)(listed files of differences between the two current versions)

In the equation above, the symbol U represents union. An outgoing KB package obtained in this way is effective for use in upgrading all KB versions that match the current major version.

In practice, a software that is upgraded by using this method for generating an incremental update package according to the disclosure, may apply the following naming rules to its corresponding versions: major version number, minor version number, Build number, and Release number. For example, the version number of a certain software version may be referred to as: 7.0.2686.203, wherein 7 represents the major version number, 0 represents the minor version number, 2686 represents the Build number, and 203 represents the Release number. Build number grows each time a version goes through a compilation process, while Release number is primarily configured as a tag for an outgoing version.

According to the version definition rules described above, when generating a KB package, say, during an upgrade from version 1.0.7.201 to 1.0.10.201, the KB package required is the listed files of differences between version 1.0.7.201 and version 1.0.10.201, denoted as KB01(1.0.10.201). When upgrading from version 1.0.7.201 to 1.0.15.201 is needed, the KB package required can be generated with the following equation:

KB02(1.0.15.201)=[KB01(1.0.10.201)] [KB02′(1.0.15.201)]

wherein KB01(1.0.10.201) represents an KB package for upgrading from version 1.0.7.201 to version 1.0.10.201 , KB02′(1.0.15.201) represents the listed files of differences between version 1.0.10.201 and version 1.0.15.201.

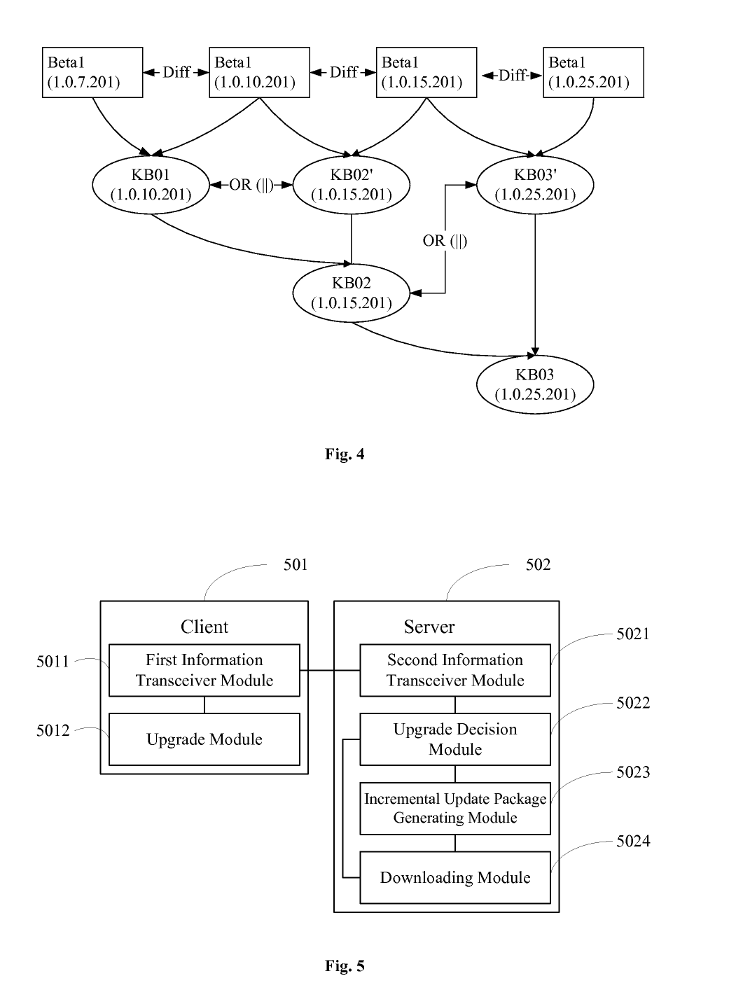

FIG. 4 is a schematic of the principles of generating incremental update package according to a specific embodiment of the disclosure.

As shown in FIG. 4, the KB package for upgrading from version Beta1(1.0.7.201) to version Beta1(1.0.10.201) is denoted as KB(1.0.10.201), the listed files of differences between version Beta1(1.0.10.201) and version Beta1(1.0.15.201) as KB02′(1.0.15.201), and the listed files of differences between version Beta1(1.0.15.201) and version Beta1(1.0.25.201) as KB03′(1.0.25.201).

Consequentially, if it is required to upgrade from version Beta1(1.0.7.201) to version Beta1(1.0.10.201), the matching KB package KB02(1.0.15.201) may be generated with the following equation:

KB02(1.0.15.201)=[KB01(1.0.10.201)] [KB02′(1.0.15.201)]

Accordingly, if it is required to upgrade from version Beta1(1.0.7.201) to version Beta1(1.0.25.201), the matching KB package KB03(1.0.25.201) may be generated with the following equation:

KB03(1.0.25.201)=[KB02(1.0.15.201)] [KB03′(1.0.15.201)]

As described above, accompanied by FIG. 4, one shall appreciate that the KB package, KB03(1.0.25.201), comprised all the listed files of differences between version Beta1(1.0.7.201) and version Beta1(1.0.25.201). Therefore, any one of the versions Beta1(1.0.7.201), Beta1(1.0.10.201) and Beta1(1.0.15.201) may use KB03(1.0.25.201) in order to upgrade to version Beta1(1.0.25.201).

According to the method for generating KB package shown in FIG. 4, for the same major version, for example, the major version 1.*.*.* as shown in FIG. 4, only one single KB package, i.e., KB03(1.0.25.201), is required in order to upgrade all minor versions under the major version. In case that changes occur to the major version, for example, if the major version is upgraded to 2.*.*.* , another KB package matching the major version 2.*.*.* may be generated in order to upgrade all the minor versions under the current major version. In other words, a KB package matching every major version may be generated, such that it may upgrade and update all minor versions under the current major version. In that case, a matching incremental update package may be determined, and the information of the package obtained, according to server upgrade target version information.

Usually, the number of minor versions, or the number of upgrades, is limited under one major version. Therefore, a KB package generated specifically for a major version will not be of very large volume. Even if repeated files, or files that do not require upgrading, are comprised in a KB package, the KB package will not occupy excessive bandwidth resources, which enhances the efficiency of software upgrade and update.

In another embodiment, an incremental update package may be generated according to the listed files of differences between server upgrade target version and client version.

In one aspect, the occupation of network bandwidth and network flow are taken into account when, for example, a KB package is generated by creating a union of the listed files of differences between the current and the last server upgrade target versions and the last incremental update package. If the same KB package, KB03 (1.0.25.201), is used to upgrade those three versions to version Beta1(1.0.25.201), then for version Beta1(1.0.7.201), the listed files of differences comprised in the KB package are exactly all the listed files of differences it needs for upgrading. Therefore, there is no unnecessary occupation of bandwidth and the bandwidth and network flow is used properly.

However, version Beta1(1.0.10.201) and version Beta1(1.0.15.201), when upgrading to version Beta1(1.0.25.201) using KB03(1.0.25.201), will download the KB package which comprises some listed files of differences that are not required during upgrading. Although it will not occupy excessive bandwidth, the proper use of bandwidth is not maximized, resulting in waste of bandwidth to some degree. For example, during an upgrade from version Beta1(1.0.15.201) to version Beta1(1.0.25.201), the listed files of differences between the current version Beta1(1.0.7.201) and version Beta1(1.0.15.201), i.e., KB(1.0.10.201) and KB03(1.0.25.201), do not require upgrading in fact, which occupies unnecessary bandwidth to some degree.

Therefore, in order to use bandwidth more properly and efficiently, an incremental update package may be generated according to the listed files of differences between server upgrade target version and client version. Accordingly, a server, upon receiving an upgrade query request sent by a client, may determine a matching KB package according to client version and server upgrade target version, so that the selected KB package only consists of the listed files of differences between server upgrade target version and the client version. In that case, a matching incremental package may be determined, and the information of the incremental package be obtained, according to server upgrade target version and client version.

According to this embodiment, considering an upgrade from version Beta1(1.0.10.201) to version Beta1(1.0.25.201) as an example, the matching KB package may be defined as:

KB″(1.0.25.201)=[KB02′(1.0.15.201)] [KB03′(1.0.25.201]

Therefore, for a client whose installed version is Beta1(1.0.10.201), during an upgrade, the client may simply download the matching KB package, KB″(1.0.25.201), the package comprising exactly all the listed files of differences required for upgrading from version Beta1(1.0.10.201) to version Beta1(1.0.25.201). It will not contain unnecessary listed files of differences, and thus use the bandwidth properly without any waste of the bandwidth.

According to the method for generating KB package, it is not required to generate a matching KB package for every major version, but it is necessary to generate a KB package matching the client version. In another embodiment, if the processing capacity and response speed allow, it may generate a real-time KB package matching the client version and server upgrade target version upon receiving an upgrade query request and deciding that an upgrade is necessary. According to the upgrade method, only one matching KB package is required to be downloaded in order to upgrade a client version, even for a major version upgraded to a higher version.

In one embodiment, considering the bidirectional interaction between a client and a server as an example, the specific software upgrade and update method may be described as below:

a client, at the start of its operation, or in a while after such start, sends upgrade query information to a server to check for updates at the server, and the upgrade query information includes client version information;

the server, after receiving the upgrade query information, determines whether an upgrade is required by comparing the version numbers of the target version (server version) and the client version, wherein an upgrade is not required if the client version number is higher than or equal to the server version number, otherwise (i.e., if the former is lower than the later) an upgrade is required;

the server, when an update is required, feeds back to the client the information to be updated along with update information, the update information includes a matching KB package and the MD5 information of the KB package, etc., wherein the KB package may be generated according to the current client version and server upgrade target version, or it may be a uniform KB package matching the server major version or server upgrade target version; moreover, new version features, upgrade method, and other types of information, may also be included in the update information; particular types of the other types of information may be configured according to different requirements in practice, and will not be elaborated here;

the client, when receiving the feedbacks sent by the server, and when the user chooses to update, downloads the matching KB package;

the client, when the matching KB package has been downloaded, checks the consistency of the MD5 of the KB package downloaded with the MD5 in the update information; if inconsistent, which indicates a failure in KB package downloading, the client ends the current update process or re-downloading the KB package;

if consistent, which indicates a success in downloading the correct KB package, the client runs and installs the KB package, wherein the installation may be overwrite installation, the details of which will not be elaborated here;

the client, if the KB package installation is unsuccessful, which indicates unsuccessful update, ends the current update process, or performing other operation, such as reinstallation, etc.;

the client, if the KB package installation is successful, which indicates successful software update to the current version, ends the upgrade and update process.

According to another aspect of the disclosure, a software update system is provided. The software update system may only include either a client or a server, or comprise both at the same time. For the purpose of illustration, FIG. 5 shows a structural schematic of a software update system according to an example combining a client and a server.

As shown in FIG. 5, the client 501 of the software update system of the current example includes a first information transceiver module 5011 and an upgrade module 5012.

The first information transceiver module 5011 is configured to send upgrade query information to a server 502, receive update information from the server when the server determines an upgrade is needed according to the client version information and server upgrade target version information, send download request information to the server, and receive an incremental update package sent by the server, the upgrade query information comprising client version information, the update information and the download request information comprising incremental update package information, and the package matching with the incremental update package information;

The upgrade module 5012 is configured to update according to the incremental update package received by the first information transceiver module 5011.

As shown by FIG. 5, the server 502 of the software update system of this embodiment includes a second information transceiver module 5021 and a downloading module 5023.

The second information transceiver module 5021is configured to receive upgrade query information and download request information, wherein the upgrade query information includes client version information, the download request information includes the incremental update package information.

The upgrade decision module 5022 is configured to decide whether an upgrade is needed according to client version information and server upgrade target version information and, when an upgrade is deemed to be necessary, send update information back to the client, the update information includes incremental update package information.

The downloading module 5023 is configured to send to the client the incremental update package matching the incremental update package information according to the download request information, wherein the incremental update package includes a set of listed files of differences determined according to server upgrade target version information.

According to this aspect, the incremental update package includes a set of listed files of differences determined according to server upgrade target version.

According to one embodiment, the software update system of the disclosure may further include incremental update package generating module 5024, configured to generate the incremental update package.

According to one embodiment, the incremental update package generating module 5024 may generate an incremental update package by creating a union of the listed files of differences between the current and the last server upgrade target version and the last incremental update package. In this aspect, the incremental update package may match the major version of the server upgrade target version.

According to another embodiment, the module 5024 may generate the incremental update package using the listed files of differences between client version and server upgrade target version. In other words, the incremental update package received by a client is generated according to the listed files of differences between the client version and the server upgrade target version.

According to yet another embodiment, the update information may further include MD5 information or address information of incremental update package, or their combination, or may further include other relevant information, such as new version feature description.

The embodiments of the functions of the software update system according to the disclosure, including specific upgrade and update methods, incremental update package generating methods, methods for deciding whether upgrade and update is needed, etc., may be the same as the methods described above according to the disclosure.

A person skilled in the art shall understand that, all or part of the process to implement the methods in the example of the disclosure may be achieved by computer programs instructing relevant hardware, the program may be stored in a computer readable storage medium, wherein running the program may perform a process comprising the aforementioned methods in the examples. According to this aspect, the storage medium may be magnetic disk, optical disk, Read-only Memory (ROM), or Random Access Memory (RAM). As a result, according to the technical solution mentioned above, one of the aspects of the disclosure may provide a storage medium comprising computer readable programs, wherein running the program may implement any one of the aforementioned methods of the disclosure.

According to the methods in the above embodiments, it may be installed in form of a software on a proper machinery device and, when running the software, complete the aforementioned software update process by controlling relevant processing devices. Accordingly, the client may be configured to install on a proper terminal device, or the client may be the terminal device itself, wherein the terminal device may be mobile phones, tablet PC, PDA (Personal Digital Assistant), POS (Point of Sales), vehicle-mounted computer, or any other terminal device. The client may be configured to install on a matching server which provides upgrade services, or it may refer to the server itself which provides upgrade services.

Therefore, according to the aforementioned software update method and software update system, one aspect of the disclosure further provides a terminal device and a server, the terminal device may be mobile phones, tablet PC, PDA (Personal Digital Assistant), POS (Point of Sales), vehicle-mounted computer, or any other terminal device that may need to upgrade and update relevant software.

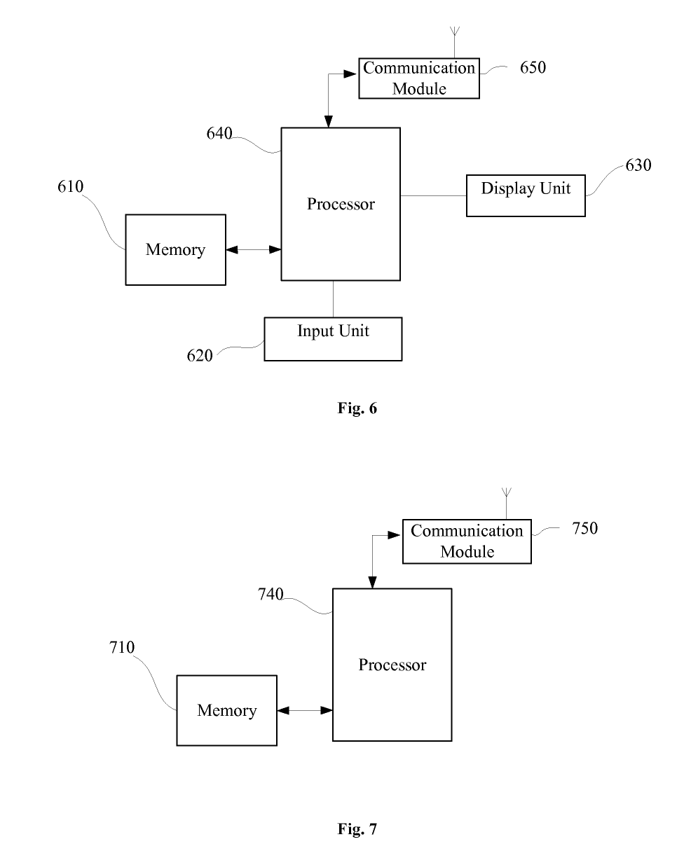

Taking a terminal device as an example, the partial structure diagram of the terminal device is shown in FIG. 6. The terminal device includes: a memory 610, an input unit 620, a display unit 630, a processor 640, a communication module 650, and other components. A person skilled in the art shall understand that, the structure shown in FIG. 6 is only illustrative of partial structure related to the technical solution in the example of the disclosure and is not intended to limit the scope of the terminal devices applied in the disclosure. Specific terminal devices in practice may comprise more or less components than shown in the figures, or a combination of certain components, or a different configuration of components.

As follows are detailed descriptions of each structural component of the terminal device, referring to FIG. 6.

The memory 610 may be configured to store software programs and modules. The processor 640 performs various functional applications and data processing by running software programs and modules stored in the memory 610. The memory 610 may mainly include program storage area and data storage area, wherein the program storage area may store operating system, applications need by at least one function (e.g., audio player, image display, etc.), etc., and the data storage area may store data created according to the use of the terminal device. Furthermore, The memory 610 may include high-speed random access memory, as well as a nonvolatile memory, e.g., at least one magnetic disk memory device, flash memory device, or any other volatile solid-state memory device.

The input unit 620 may be configured to receive inputs of numbers, characters, or any other information, and generate key signal input associated with user settings and functional control of a terminal device. Particularly, in the embodiments of the examples of the disclosure, when auto upgrade is disabled, the input unit 620 may be configured to receive user instructions that confirm an upgrade.

Particularly, taking a mobile phone as an example, the input unit 620 may include a touch panel and other input devices. Touch panel, or touch screen, may collect touch operations conducted by a user on or near it (e.g., a user operates on or near touch panel with finger, touch pen, or any other appropriate object or accessory), and actuate a corresponding connection device according to pre-set program. Alternatively, the touch panel may comprise two parts, a touch detector device and a touch controller. In this aspect, the touch detector device detects the location of a user touch and the signal accompanying such a touch operation and sends such signal to the touch controller. The touch controller receives the touch information from the touch detector device and transforms it into contactor coordinates before sending it to the processor 640; meanwhile, it also receives and performs instructions from the processor 640. Furthermore, the touch panel may be implemented in many ways, such as resistance-type, capacitance, infrared, and surface acoustic wave. The input unit 620 may also comprise input devices other than touch panel. Specifically, the other input devices may include, but not limited to, one or more of a physical keyboard, function keys (e.g., volume control keys, an on/off switch, etc.), a trackball, a mouse, action bars, etc.

The display unit 630 may be configured to display information input by a user or information and various menus provided to a user. The display unit 630 may comprise display panel. Optionally, the display panel may be configured with a liquid crystal display (LCD), organic light-emitting diode (OLED), etc. Particularly, in this example, when auto upgrade is disabled, the display unit 630 may show to a user the message sent by a server indicating information requiring an upgrade, so that the user may decide whether to proceed with the upgrade at the time or not. The display unit 630 may also be configured to show to a user the upgrade process and upgrade results.

The communication module 650 may make it possible for a terminal device to communicate with a server, the communication module 650 may be any possible type of its kind, such as, an WiFi module, bluetooth communication, fiber optic communication, etc. Communication module 650 may make it possible for a terminal device to communicate with a server, so that the terminal device may send relevant information (e.g., upgrade query information, download request information, etc., in this example of the disclosure) to the server and receive relevant information (e.g., update information, incremental update package, etc.) sent by the server.

The processor 640 is the control center of a terminal device, which monitors and controls the entire terminal device by connecting to various parts of the entire terminal device through different ports and line connections, running or performing software programs and/or modules stored in the memory 610, call data stored in the memory 610, and performing all kinds of functions and data processing of the terminal device. Alternatively, the processor 640 may include one or more processing units.

Similarly, FIG. 7 is a partial structural diagram of a server according to the disclosure. The terminal device includes: a memory 710, a processor 740, a communication module 750, and other components. A person skilled in the art shall understand that, the structure illustrated in FIG. 7 only shows a part that is relevant to the technical solution of the disclosure, and does not constitute a limitation to the server applied in the disclosure. Specific servers in practice may comprise more or less components than shown in the figure, or a combination of certain components, or a different component configuration.

The memory 710 may be configured to store software programs and modules. Processor 740, by running software programs and modules stored in memory 710, performs various functional applications and data processing related to the server, such as deciding whether an upgrade is needed based on upgrade query information, deciding which incremental update package to send, generating incremental update package, etc. The memory 710 may mainly comprise a program storage area and data storage area, wherein the program storage area may store operating system, applications needed by at least one function (e.g., analyzing whether an upgrade is needed, deciding which incremental update package to send, etc.), etc.; the data storage area may store data created according to the use of the terminal device.

The communication module 750 may make it possible for a terminal device to communicate with a server. The communication module 750 may be any possible type of its kind, such as, a WiFi module, bluetooth communication, fiber optic communication, etc. The communication module 750 may make it possible for a terminal device to communicate with a server, so that the terminal device may send relevant information (e.g., upgrade query information, download request information, etc., in this example of the disclosure) to the server and receive relevant information (e.g., update information, incremental update package, etc.) sent by the server.

The processor 640 is the control center of a terminal device, which monitors and controls the entire terminal device by connecting to various parts of the entire terminal device through different ports and line connections, running or performing software programs and/or modules stored in the memory 610, call data stored in the memory 610, and performing all kinds of functions and data processing of the terminal device. Alternatively, the processor 640 may include one or more processing units.

The embodiments are chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for updating software, comprising:
sending, by a client, upgrade query information to a server, the upgrade query information including client version information;
receiving, by the client, update information from the server when the server determines an upgrade is needed according to the client version information and server upgrade target version information, the update information including incremental update package information;
sending, by the client, download request information to the server, the download request information including the incremental update package information; and
receiving, by the client, an incremental update package sent by the server, the package matching with the incremental update package information, and updating according to the incremental update package.

2. The method of claim 1, wherein the incremental update package includes a set of listed files of differences determined according to server upgrade target version.

3. The method of claim 2, wherein the incremental update package information is obtained through the server upgrade target version information by the server.

4. The method of claim 3, wherein the incremental update package is generated by creating a union of the listed files of differences between the server upgrade target version and the last server upgrade target version and the last incremental update package.

5. The method of claim 4, wherein the incremental update package matches the major version of the server upgrade target version.

6. The method of claim 2, wherein the incremental update package information is obtained by the server through the client version information and the server upgrade target version information.

7. The method of claim 6, wherein the incremental update package is generated by the listed files of differences between the client version and the server upgrade target version.

8. The method of claim 1, wherein the update information further comprises MD5 information and/or address information of the incremental update package.

9. A method for updating software, comprising:
receiving, by a server, upgrade query information, the upgrade query information including client version information;
determining whether an upgrade is needed according to the client version information and server upgrade target version information; if so, sending update information to the client, the update information comprising incremental update package information; and
receiving download request information sent by the client, the download request information including the aforementioned incremental update package information, and sending an incremental update package to the client for the client to update, the package matching with the incremental update package information.

10. The method of claim 9, wherein the incremental update package includes a set of listed files of differences determined according to server upgrade target version.

11. The method of claim 10, wherein the incremental update package information is obtained according to the server upgrade target version information.

12. The method of claim 11, wherein the incremental update package is generated by creating a union of the listed files of differences between the server upgrade target version and the last server upgrade target version and the last incremental update package.

13. The method of claim 12, wherein the incremental update package matches the major version of the server upgrade target version.

14. The method of claim 10, wherein the incremental update package information is obtained according to the client version information and the server upgrade target version information.

15. The method of claim 14, wherein
the incremental update package is generated according one of the the listed files of differences between the client version and the server upgrade target version and real time by the server according to the listed files of differences between client version and the server upgrade target version.

16. The method of claim 10, wherein the update information further includes MD5 information and/or address information of the incremental update package.

17. A system for updating software implemented in a client, including a processor and memory having instructions stored thereon, the instructions, when executed by the processor, cause the processor to perform operations comprising:
sending upgrade query information to a server, the upgrade query information including client version information;
receiving update information from the server when the server determines an upgrade is needed according to the client version information and server upgrade target version information, the update information including incremental update package information;
sending download request information to the server, the download request information including the incremental update package information; and
receiving an incremental update package sent by the server, the package matching with the incremental update package information, and updating according to the incremental update package.

18. The system of claim 17, wherein the incremental update package includes a set of listed files of differences determined according to server upgrade target version.

19. The system of claim 18, wherein the incremental update package matches the major version of server upgrade target version.

20. The system of claim 18, wherein the incremental update package is generated by the server according to the listed files of differences between the client version and the server upgrade target version.
